(19) United States
(12) Patent Application Publication
(10) Pub. No.: US 2012/0129726 A1
(43) Pub. Date: May 24, 2012

(54) SUBCELLULAR IN VIVO TIME-LAPSE IMAGING AND SURGERY OF C. ELEGANS IN STANDARD MULTIWELL PLATES

(75) Inventors: Christopher B. Rohde, Cambridge, MA (US); Mehmet F. Yanik, Watertown, MA (US)

(73) Assignee: Massachusetts Institute of Technology, Cambridge, MA (US)

(21) Appl. No.: 12/951,117

(22) Filed: Nov. 22, 2010

(51) Int. Cl. C40B 30/06; C40B 60/14

(52) U.S. Cl. 506/10; 506/40

(57) ABSTRACT

High-content time-lapse assays on whole animals require their repeated immobilization for high-resolution imaging and manipulation. Here, we present a simple, rapid, and minimally invasive method for repeatedly immobilizing and imaging Caenorhabditis elegans (C. elegans) over extended periods of time inside standard multiwell plates, which are compatible with industrial high-throughput screening platforms and robotics. We use this method to perform subcellular-resolution femtosecond laser microsurgery, and to image the regeneration dynamics of single neurons in vivo at cellular resolution. Our analysis shows that mechanosensory neurons often regenerate in single short bursts that occur stochastically within the first two days post-surgery. In vivo observation of many such physiological processes requires multi-time-point immobilization and imaging of large numbers of animals throughout extended periods of time.

This invention was made with government support under Grant No. 1-DP2-OD002989-01, awarded by the National Institutes of Health and under Grant No. CBET-0845347, awarded by the National Science Foundation. The government has certain rights in this invention.”

### BACKGROUND OF THE INVENTION

This invention relates to whole-animal screening and more particularly to a system for cooling animals in wells of a multiwall plate to immobilize them for high resolution imagining and manipulation.

High-throughput screening (HTS) allows rapid identification of potential therapeutic targets and leads. Although high-throughput assays can be performed in vitro, thorough study of many biological phenomena, such as development, organogenesis, regeneration, and aging, requires the use of animal models. The use of multicellular organisms also facilitates identification of off-target or toxic effects. The nematode Caenorhabditis elegans (C. elegans) is one of the most commonly used multicellular organisms for high-throughput screening. Since nematodes can be cultured and screened in liquid, many techniques currently used for screening cells can be adapted for C. elegans. The small size and simple physiology of C. elegans make it suitable for culture in 96- and 384-well plates in small volumes. Because C. elegans is optically transparent, it also permits visualization of internal organs. Today, high-content and time-lapse assays on C. elegans are often used and crucial for most studies. However, these constantly moving organisms must be immobilized to image cellular and subcellular processes. In addition, many physiological processes are stochastic and time dependent (i.e. development, aging), which requires multi-time-point immobilization and imaging of individual animals.

Commercially available technologies for HTS of C. elegans utilize flow cytometry¹⁻³. Despite their speed, these systems can acquire only one-dimensional fluorescence images. Thus, assays requiring analysis of cellular and subcellular features are not feasible. Additionally, optical measurements and manipulations such as multiphoton⁴ and confocal imaging, laser stimulation, and laser microsurgery^{5,6} are not possible with such approaches.

Recently, we and others developed microfluidic approaches for immobilization of C. elegans for high-throughput and high-content screening. Mechanical immobilization (both active⁷⁻⁹ and passive¹⁰ and cooling¹¹ have been used to enable and short-term immobilization. Three-dimensional multiphoton imaging⁸ and femtosecond laser microsurgery^{8,9} have both been demonstrated in some of these devices. We previously also demonstrated multiplexed microfluidic chambers for long-term incubation, immobilization and imaging of C. elegans⁷. Other approaches since then have used CO₂¹², tapered channels¹³ or temperature-sensitive gel¹⁴ combined with microfluidics to enable longer-term time-lapse imaging of animals. Despite their capabilities, these microfluidic systems are still too complex to manufacture, operate, maintain, and scale for mainstream use. Integration of these techniques into existing HTS platforms using multiwell plates for large-scale incubation of C. elegans has not been achieved, and is challenging due to well-known “world-to-chip” fluidic interface issues¹⁵. Although C. elegans can be anesthetized in multiwell plates for immobilization and imaging, effects of anesthesia are slow and variable, and removal of the anesthetic media without losing animals is highly unreliable. Additionally, exposure to anesthetics has side effects¹⁶.

### SUMMARY OF THE INVENTION

According to a first aspect, the whole-animal screening system of the invention immobilizes animals inside a multi-well plate or a similar structure having wells for receiving a liquid medium with one or more animals immersed therein. One or more cooling elements are provided for cooling a selected well or wells in the multi-well plate to immobilize one or more animals. In a preferred embodiment, each cooling element includes a thermoelectric cooler sandwiched between a first thermally conductive pin for insertion into a well and a second thermally conductive pin to dissipate heat. In this embodiment, the first pin is made of aluminum and the second pin is made of copper. This embodiment may further include a copper back plane for thermal contact with the second pins for heat removal. Another preferred embodiment utilizes aluminum pins for cooling and a single thermally conductive block for heat dissipation of all cooling elements. It is also preferred that a portion of the well be optically transparent to permit imaging of the immobilized animal. The imaging may be accomplished using inverted epi-fluorescence microscopy. A preferred experimental animal is C. elegans.

In another aspect, the invention is a method for whole-animal screening including disposing a liquid medium with an animal therein in a well of a multi-well plate and cooling the well to immobilize the animal. The method further includes imaging the immobilized animal which is preferably C. elegans.

### BRIEF DESCRIPTION OF THE DRAWING

FIG. 1a is a perspective view of the individual cooling elements, arranged in an array to match various well configurations and showing imaging capability.

FIG. 1b is a bar graph showing the time required for imaging animals inside a well plate with a single animal per well.

FIG. 1c is a multi-channel fluorescence image of an animal immobilized using in-well cooling.

FIG. 1d are fluorescence images of an animal before (left) and after (right) cooling.

FIG. 1e is a graph showing the effects of cooling for five minutes every hour on lifespan.

FIG. 2a is a photograph showing localized ablation and regeneration of interior lateral mechanosensory (ALM) axon.

FIG. 2b is a bar graph showing the effect of immobilization on regeneration following axotomy.

FIG. 2c is a bar graph showing the effect of multiple immobilizations (every six hours for 48 hours) on regeneration.

FIG. 3a are photographs of time-lapse imaging and analysis of stochastic neuronal regeneration in multi-well plates showing regeneration of an axon.

FIG. 3b are representative curves of calculated growth rate of regenerating branch versus time.

FIG. 3c is a graph showing the percent of total regeneration occurring over a moving time window.

FIG. 3d is a scatter plot showing the distribution of the center of an 18-hour window in which 75% of regeneration occurs.

### DESCRIPTION OF THE PREFERRED EMBODIMENT

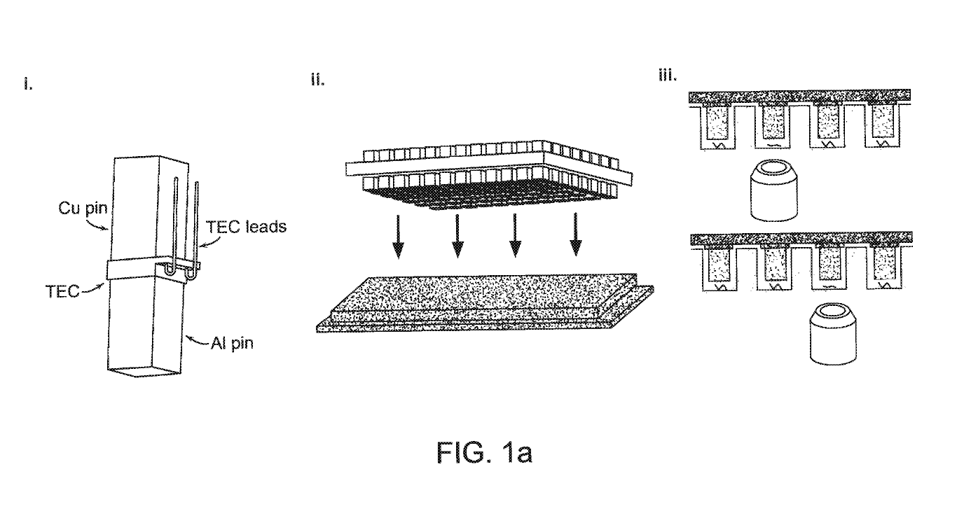

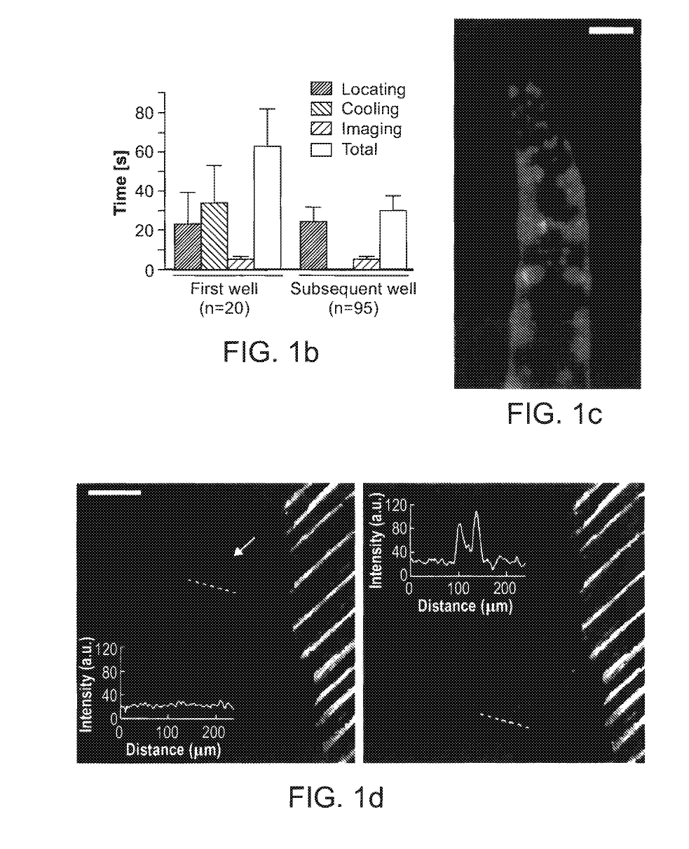

It is well known that cooling reduces motion of C. elegans¹⁷. Our device consists of one or more cooling elements that rapidly decrease the temperature of wells. Each individual cooling element consists of a small square thermoelectric cooler bonded to an aluminum pin that is inserted into the well and a copper pin that is used to dissipate heat (FIG. 1a.i). The copper pins of the individual cooling elements are slotted into a copper backplane that is passively cooled, and the individual pins are inserted into the wells (FIG. 1a.ii). This design is easily scalable to different well numbers and dimensions by changing the size of the pins and coolers and arraying them in various configurations. Independent control of well temperatures allows rapid screening of wells by pipelining: While animals in one well are being imaged using inverted epi-fluorescence microscopy, the neighboring wells can be gradually cooled to immobilize the animals in preparation for subsequent imaging and manipulation (FIG. 1a.iii). Once the animals in the first well are imaged they are immediately recovered to room temperature, and it takes approximately 30 s to locate and image animals in the subsequent wells, including the time required to move the multiwell plate, change objectives for high-resolution imaging, store images, and switch back to a low-magnification objective (FIG. 1b). During the low-temperature period, cellular-resolution fluorescence images of entire animals can be acquired (FIG. 1c). FIG. 1d shows an animal before and after cooling and highlights the drastic improvement in image resolution. We performed lifespan measurements to assess whether this technique influences animal health under frequent immobilization and imaging conditions, and the difference between the lifespan of the repeatedly cooled animals (for 5 min every hour for 24 hours) and the lifespan of the control group (FIG. 1e) was non-significant (P=0.61).

Individual cooling elements consist of a 6.6 mm×6.6 mm thermoelectric cooler (TEC) (NL1011T-01AC, Marlow Industries) and aluminum and coppers pins cut from ¼″ square rod. The aluminum pin is attached to the cooled surface of the TEC and the copper pin is attached to the opposite side of the TEC using a thermal adhesive (Arctic Alumina, Arctic Silver). A ¼″ thick copper backplane with ¼″ square holes cut into it is used to array the cooling elements and provide additional heat dissipation. The opposite (hot) surface of the TEC is attached to a larger metal heatsink common to all the TEC/pin assemblies, again with thermal adhesive. The individual TECs are powered by a DC power supply set to 1.25 V (CS13005X III, Circuit Specialists), which draws a current of approximately 0.7 A per active TEC. The entire device is placed in a 96-well plate with thin glass bottom (MGB096-1-2-LG-L, Matrical) so that wells can be imaged by a standard inverted epi-fluorescence microscope (Eclipse Ti-U, Nikon). Anti-fog drops (FogTech) are used to prevent condensation on the underside of the glass during cooling.

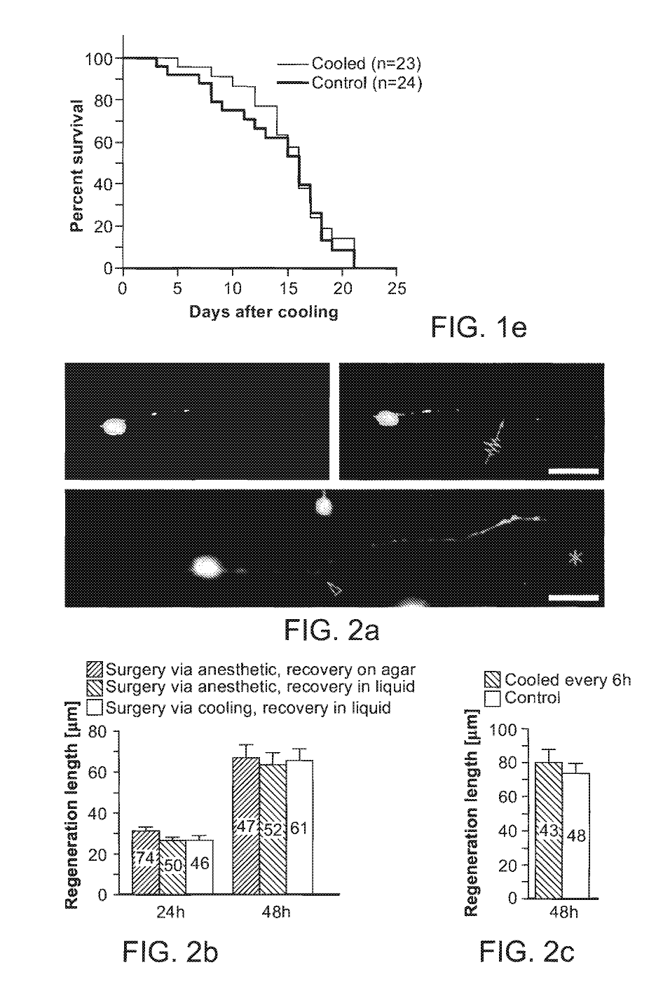

Our technique also enables the use of subcellular-resolution optical manipulation methods such as femtosecond laser microsurgery in multiwell plates¹⁸. Precise targeting of axons by laser for microsurgery becomes possible when the animals are immobilized by cooling (FIG. 2a, top panel). Following surgery, axons regenerate (FIG. 2a, bottom panel) as we previously showed in the first studies of axonal regeneration in C. elegans^{5,6}. We first determined whether cooling affects regeneration by examining three different surgery conditions in young-adult animals. We performed surgery both on anesthetized animals on glass slides, and on animals immobilized using in-well cooling. Following surgery, the animals axotomized under anesthesia were split into two populations, one population recovered on agar plates, and the other population recovered in a 96-well plate with liquid culture in the wells. Regeneration was observed 24 and 48 h following injury, and no significant difference was found between the regeneration observed in animals immobilized by in-well cooling and those immobilized by anesthesia (FIG. 2b). We also examined whether frequent immobilizations following femtosecond laser microsurgery affect regeneration: There was no significant difference (P=0.52) in the regeneration observed 48 h post-surgery between a population cooled for 5 min every 6 h and a control population that was not cooled but was maintained under otherwise identical conditions (FIG. 2c).

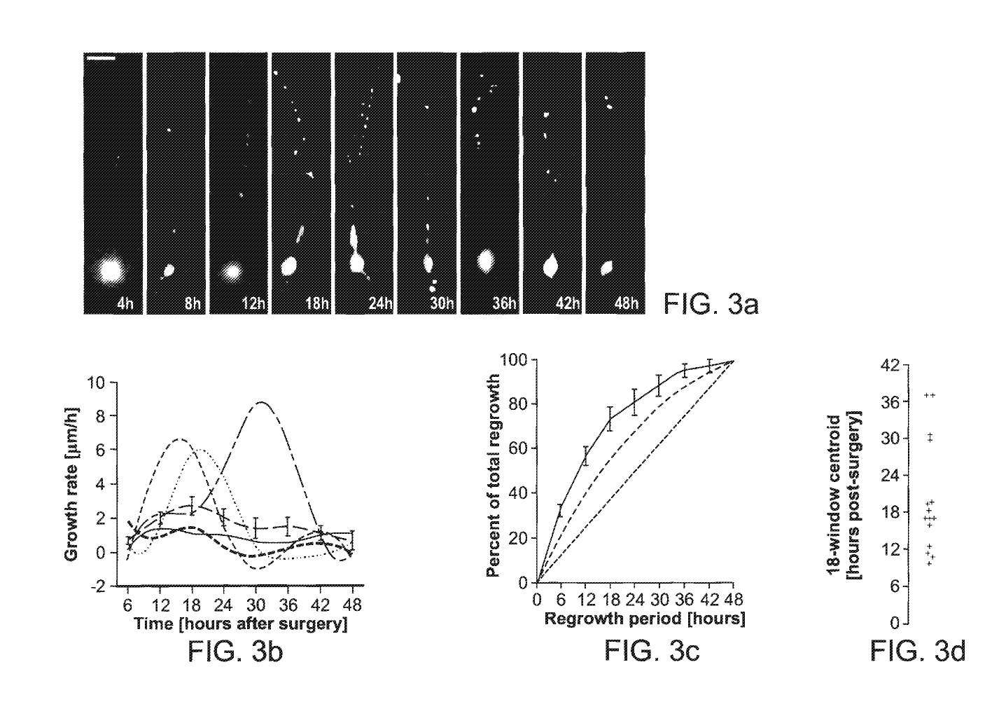

Following surgery, we examined the axonal regeneration dynamics by frequently immobilizing and imaging several animals (FIGS. 3a and 3b) over a 48-hour time window. Analysis of single neurons showed that the majority of regeneration (75%) occurs within a short 18-hour window (FIG. 3c), yet the timing of this window varies drastically from animal to animal (FIGS. 3b and 3d). Interestingly, this window was more likely to occur at later times for axons that regenerated more than the median amount, although this difference was not statistically significant ( t̅=15 h and 24 h in shorter vs. longer axons, P=0.12). In the absence of repeated single animal immobilization and imaging, only statistical averages can be obtained from end-point measurements on many animals. Such averaging incorrectly predicts that the maximum regenerative growth of ALM neurons occurs during the first 24 hours (red dashed line in FIG. 3b and FIG. 3d). Use of the average regeneration rate also incorrectly predicts a significantly smaller amount of regrowth during any 18-hour window (58% vs. 75%, P=0.008).

### EXPERIMENTS

Nematodes were grown at 15° C. in NGM agar plates, unless otherwise stated. Standard procedures were followed for C. elegans maintenance²⁶. Nematode strains used in this study included SD1726: Is[pₕᵢₛ₋₇₂GFP; p_{unc-54}H1::mCherry; pₚₕₐ₋₄mCherry] and SK4005: zdIs5[p_{mec-4}GFP]I. The former strain was a gift from the lab of Stuart Kim and the latter strain was obtained from the CGC.

Age synchronizations were performed by transferring approximately 25 gravid adults to a fresh NGM agar plate and allowing them to lay eggs for 6 h at 20° C. Following egg laying, the adults were removed and the plates were left at 15° C. for the animals to grow normally.

Lifespan analysis was carried out on two populations of animals incubated in 96-well plates, with 6 animals and 150 μl, of liquid NGM medium supplemented with OP50 per well. The first population was cooled for 5 min every hour over a 24 h period and was left at room temperature for the remaining time. The control population was not cooled and was left at room temperature. Subsequently, both populations were transferred to agar plates with OP50 feeding bacteria to recover. Animals were observed once per day to assess mortality, and transferred to new plates when needed.

Experiments were also performed to assess immobilization and acquisition times. Animals were incubated in 96-well plates with one animal per well in 100 μl, of liquid NGM medium supplemented with OP50. The times required to cool a well, locate the position of an 210 animal, and to acquire an image were recorded. The time reported for locating position includes moving the position stage from well to well, locating an animal using a 2.5x objective lens, switching to a 20x/0.75 NA objective lens, and focusing on an axon. For the first well of the plate, additional time was required for the cooling to halt the movement of the animals (FIG. 1b). The imaging time included acquiring an image using a 750 ms exposure time, writing the image to disk, and switching back to the 2.5x objective lens.

For laser surgery, the optical path was set up as previously described¹⁸. To perform femtosecond laser microsurgery, a Mai-Tai® HP (Spectra-Physics) femtosecond laser beam with 800 nm wavelength and 80 MHz repetition rate was delivered to the specimen via an inverted microscope (Eclipse Ti-U, Nikon). ALM axons were axotomized by pulses with 7 nJ energy for 1.5 ms using a 20x/0.75 NA objective lens. For laser surgery on glass slides, synchronized nematodes were immobilized in 2% agarose pads with 10 mM NaN₃. Measurements of axon regeneration were performed using a MATLAB program.

We performed surgery both on animals anesthetized on agar pads, and on animals immobilized using in-well cooling. We cut one ALM axon per animal, 50 μm from the soma, using the laser parameters described above. Following surgery, we split the animals axotomized under anesthesia into two populations both kept at 20° C. One population recovered on agar plates while the other population recovered in a 96-well plate with 6 animals per well in 150 μL of liquid NGM medium supplemented with OP50. The animals axotomized using in-well cooling were left in a 96-well plate with 6 animals per well in 150 μL of liquid NGM medium supplemented with OP50. Regeneration length was measured either 24 or 48 h following injury.

Surgeries were also performed on young adult animals 50 μm from the ALM soma. Animals were immobilized using cooling in 96-well plates with 6 animals per well in 100 μL of liquid NGM medium supplemented with OP50. Following surgery, one population was cooled for 5 min/well every 6 h while the control population recovered at 20° C. Regeneration length was measured 48 h post surgery.

Surgeries were performed on young adults. Animals were incubated in 96-well plates with 100 μL of liquid NGM medium supplemented with OP50 per well at 20° C. The animals were immobilized by in-well cooling and imaged at multiple time points (4, 8, 12, 18, 24, 30, 36, 42 and 48 h post surgery). Regeneration length at 6 h was calculated by averaging data at 4 h 240 and 8 h. Growth rates from 6 h-42 h were calculated from the regrowth length using a center difference method and the 48 h growth rate was calculated using a backwards difference method, although the 48 h growth rate was not used in calculating growth over a particular window duration. Interpolations were performed using MATLAB spline function. The centroids of the time windows were calculated as

$$T = \frac{Σ {v}_{i} {t}_{i}}{Σ {v}_{i}}$$

where νᵢ is growth rate data from the time points tᵢ that make up the time window.

Comparisons of regeneration lengths were performed using a two-tailed Student's t-test. Lifespan analysis was performed with the log-rank (Mantel-Cox) test using the GraphPad Prism software package.

Performing screens using multiwell plates according to the invention confers several significant benefits. Because multiwell plates are commonly used in many platforms, there already exists a wealth of equipment, robotics, and protocols for screening in this format. As a result, our technology can expand the use of existing HTS systems to perform high-content multicellular organism screens at subcellular resolution. High-speed precise liquid handling equipment can be used to rapidly dispense precise volumes of screening compounds, and multiwell plates also simplify isolation of individual animals for multi-time-point tracking of single animals throughout the experiments. The use of multiwell plates also eliminates the “world-to-chip” fluidic interface issues encountered with current micro fluidic devices for large-scale incubation of animals as well as the risk of cross-contamination. Our cooling apparatus could be manipulated with existing high-throughput robotics, and also does not require any fluidic components, and thus it is not susceptible to clogging or loss of animals. No side effects on animal lifespan are observed even after frequent immobilization and imaging of animals at multiple time points.

Both forward- and reverse-genetic, as well as chemical assays on C. elegans are possible in high-throughput compatible multi-well plate format at subcellular resolution using our technology. As is commonly done, animals can be dispensed to 96- or 384-well microtiter plates either by flow sorters¹, or by manual or automated liquid dispensers. Our device subsequently allows immobilization of animals in the individual wells for imaging at multiple time points. Forward genetic screens can be performed if mutagenized animals are dispensed to the wells. Reverse-genetic or chemical screens can be performed if the animals are incubated in wells containing either chemicals or dsRNA expressing bacteria. The pins can be sterilized either by commercial pin washers or via heating by running the thermoelectric cooler in reverse. There are also a number of powerful image processing algorithms that, combined with our technology, can further enhance the ability to perform high-throughput and high-content screens on C. elegans. Using a low-magnification objective, an entire well can be imaged and the location of individual animals can be determined automatically¹⁹. Higher resolution images of individual animals can be automatically straightened in 3D²⁰, which simplifies animal comparison and results in smaller file sizes. Automated cell-lineage tracing²¹, three-dimensional nuclei segmentation²², and cell-body ablation²³ have all been demonstrated for C. elegans. Our work enables the use of these advanced image processing techniques in a HTS-compatible format.

Time-lapse analysis can yield significant insight into many physiological processes that cannot be gained through end-point assays, as we illustrated here for neuronal regeneration. Temporal analysis previously also helped elucidate the role of the DLK-1 mitogen-activated protein kinase pathway in axonal regeneration in C. elegans²⁴. The ability to perform precise neural injury and to image regeneration over time in a genetically amenable organism, in a format compatible with existing HTS systems, can drastically accelerate investigations on neural degeneration and regeneration following injury. Similarly, imaging time-resolved expression patterns of many genes using fluorescent reporters such as elt-3::GFP, ugt-9::GFP, and col-144::GFP²⁵ can facilitate the study of the aging process under variety of dietary, genetic, and environmental conditions.

We have demonstrated a simple method to rapidly and noninvasively immobilize C. elegans in standard multiwell plates at multiple time points by modulating the temperature of individual wells. Our method is compatible with existing instruments, robotics, and protocols used in industrial high-throughput screening platforms. Our technology can significantly accelerate most C. elegans investigations. Only a few minutes in total are needed to immobilize the animals when screening an entire plate, and animals are immobilized only for the brief period they are imaged, thus minimizing stress. Using this technology, we study the regeneration dynamics of single neurons in individual animals over time using laser microsurgery in multiwell plates. We show that the majority of neuronal regeneration of ALM axons typically occurs in a single short burst of regenerative growth (i.e. 18 h) that occurs at stochastic instances.

It is recognized that modifications and variations of the invention disclosed herein will be apparent to those of skill in the art and it is intended that all such modifications and variations be included within the scope of the appended claims.

### REFERENCES

1. Pulak, R. Techniques for analysis, sorting, and dispensing of C. elegans on the COPAS flow-sorting system. Methods Mol Biol 351, 275-286 (2006).
2. Rea, S. L., Wu, D., Cypser, J. R., Vaupel, J. W., & Johnson, T. E. A stress-sensitive reporter predicts longevity in isogenic populations of Caenorhabditis elegans. Nat Genet 37, 894-898 (2005).
3. Doitsidou, M., Flames, N., Lee, A. C., Boyanov, A., & Hobert, O. Automated screening for mutants affecting dopaminergic-neuron specification in C. elegans. Nat Methods 5, 869-872 (2008).
4. Denk, W., Strickler, J. H., & Webb, W. W. Two-photon laser scanning fluorescence microscopy. Science 248, 73-76 (1990).
5. Yanik, M. F. et al. Nerve regeneration in Caenorhabditis elegans after femtosecond laser axotomy. IEEE Journal of Selected Topics in Quantum Electronics 12, 1283-1291 (2006).
6. Yanik, M. F. et al. Neurosurgery: functional regeneration after laser axotomy. Nature 432, 822 (2004).
7. Rohde, C. B., Zeng, F., Gonzalez-Rubio, R., Angel, M., & Yanik, M. F. Microfluidic system for on-chip high-throughput whole-animal sorting and screening at subcellular resolution. Proc Natl Acad Sci USA 104, 13891-13895 (2007).
8. Zeng, F., Rohde, C. B., & Yanik, M. F. Sub-cellular precision on-chip small-animal immobilization, multi-photon imaging and femtosecond-laser manipulation. Lab Chip 8, 653-656 (2008).
9. Bourgeois, F. & Ben-Yakar, A. Femtosecond laser nanoaxotomy properties and their effect on axonal recovery in C. elegans. Opt Express 16, 5963 (2008).
10. Hulme, S. E., Shevkoplyas, S. S., Apfeld, J., Fontana, W., & Whitesides, G. M. A microfabricated array of clamps for immobilizing and imaging C. elegans. Lab Chip 7, 1515-1523 (2007).
11. Chung, K., Crane, M. M., & Lu, H. Automated on-chip rapid microscopy, phenotyping and sorting of C. elegans. Nat Methods 5, 637-643 (2008).
12. Chokshi, T. V., Ben-Yakar, A., & Chronis, N. CO2 and compressive immobilization of C. elegans on-chip. Lab Chip 9, 151-157 (2009).
13. Hulme, S. E. et al. Lifespan-on-a-chip: microfluidic chambers for performing lifelong observation of C. elegans. Lab on a Chip 10, 589-597 (2010).
14. Krajniak, J. & Lu, H. Long-term high-resolution imaging and culture of C. elegans in chip-gel hybrid microfluidic device for developmental studies. Lab on a Chip 10, 1862-1868.
15. Liu, J., Hansen, C., & Quake, S. R. Solving the “world-to-chip” interface problem with a microfluidic matrix. Anal Chem 75, 4718-4723 (2003).
16. Massie M R, L. E., Boggs K D, Stine K E, White G E. Exposure to the metabolic inhibitor sodium azide induces stress protein expression and thermotolerance in the nematode Caenorhabditis elegans. Cell Stress Chaperones 8, 1-7 (2003).
17. Podbilewicz, B. & Gruenbaum, Y. Live Imaging of Caenorhabditis elegans: Preparation of Samples. Cold Spring Harb Protoc 2006, pdb.prot4601-(2006).
18. Steinmeyer, J. D. et al. Construction of a femtosecond laser microsurgery system. Nat. Protocols 5, 395-407 (2010).
19. Wahlby, C. et al. Resolving clustered worms via probabilistic shape models in Biomedical Imaging: From Nano to Macro, 2010 IEEE International Symposium on (IEEE, 2010), pp. 552-555.
20. Peng, H., Long, F., Liu, X., Kim, S K., & Myers, E. W. Straightening Caenorhabditis elegans images. Bioinformatics 24, 234-242 (2008).
21. Bao, Z. et al. Automated cell lineage tracing in Caenorhabditis elegans. Proc Natl Acad Sci USA 103, 2707-2712 (2006).
22. Long, F. H., Peng, H. C., & Myers, E. Automatic segmentation of nuclei in 3D microscopy images of C. elegans. 2007 4th IEEE International Symposium on Biomedical Imaging: Macro to Nano, Vols 1-3, 536-539 (2007).
23. Chung, K. & Lu, H. Automated high-throughput cell microsurgery on-chip. Lab Chip 9, 2764-2766 (2009).
24. Hammarlund, M., Nix, P., Hauth, L., Jorgensen, E. M., & Bastiani, M. Axon regeneration requires a conserved MAP kinase pathway. Science 323, 802-806 (2009).
25. Budovskaya, Y. V. et al. An elt-3/elt-5/elt-6 GATA transcription circuit guides aging in C. elegans. Cell 134, 291-303 (2008).
26. Brenner, S. The genetics of Caenorhabditis elegans. Genetics 77, 71-94 (1974).

What is claimed is:

1. Whole-animal screening system comprising one or more cooling elements for cooling a well or wells in a multi-well plate to immobilize one or more animals in a well.

2. The system of claim 1 wherein each cooling element includes a thermoelectric cooler.

3. The system of claim 2 wherein one side of the thermoelectric cooler is inserted directly into the well.

4. The system of claim 2 wherein the thermoelectric cooler is positioned below the well.

5. The system of claim 3 wherein the other side of the thermoelectric cooler is attached to a thermally conductive back plane to dissipate heat.

6. The system of claim 3 wherein the other side of the thermoelectric cooler is attached to a thermally conductive pin to dissipate heat.

7. The system of claim 6 further including a thermally conductive back plane for thermal contact with the heat-dissipating pin for additional heat removal.

8. The system of claim 7 wherein the back plane is made of copper.

9. The system of claim 2 wherein the thermoelectric cooler is attached to a thermally conductive first pin for insertion into a well.

10. The system of claim 9 wherein the other side of the thermoelectric cooler is attached to a thermally conductive back plane to dissipate heat.

11. The system of claim 9 wherein the other side of the thermoelectric cooler attached to a second thermally conductive pin to dissipate heat.

12. The system of claim 11 wherein the first pin is made of aluminum and the second pin is made of copper.

13. The system of claim 12 further including a thermally conductive back plane for thermal contact with the second pins for heat removal.

14. The system of claim 13 wherein the back plane is made of copper.

15. The system of claim 1 wherein a portion of the well is optically transparent to permit imaging of the immobilized animal.

16. The system of claim 15 wherein the imaging is accomplished using inverted epi-fluorescence microscopy.

17. The system of claim 1 wherein the animal is C. elegans.

18. Method for whole-animal screening comprising: disposing a liquid medium with one or more animals therein in a well of a multi-well plate; and cooling the well to immobilize the animals.

19. The method of claim 18 further including imaging the immobilized animal.

20. The method of claim 18 wherein the animal is C. elegans.
